(19) United States
(12) Patent Application Publication
(10) Pub. No.: US 2024/0125112 A1
(43) Pub. Date: Apr. 18, 2024

(54) CONSTRUCTION METHOD FOR TRESTLE

(71) Applicant: E-Soltech, LLC, Aichi (JP)

(72) Inventor: Shuichi Kobayashi, Aichi (JP)

(73) Assignee: E-Soltech, LLC, Aichi (JP)

(21) Appl. No.: 18/090,543

(22) Filed: Dec. 29, 2022

(30) Foreign Application Priority Data
Oct. 18, 2022 (JP) 2022-166901

(51) Int. Cl. E04B 1/41

(52) U.S. Cl. CPC E04B 1/40; E04B 2001/405

(57) ABSTRACT

Provided is a construction method for a trestle whereby work efficiency of installation work of the trestle can be enhanced. The construction method of a trestle includes forming an opening in one tile of a plurality of tiles laid on a roof of a house, fixing a base of the trestle to a roofing board that is a bed of the roof through the opening, and attaching a first L-shape bracket that is a first fixing bracket to the base through the opening.

### CROSS-REFERENCE TO RELATED APPLICATION

This application claims the benefit of Japanese Patent Application No. 2022-166901, filed on Oct. 18, 2022, the entire disclosure of which is incorporated by reference herein.

### FIELD

The present disclosure relates generally to a construction method for a trestle.

### BACKGROUND

Japanese Patent No. 6034218 describes a construction method for a trestle in which a tile of a roof of a house is removed and an installation mounting bracket is attached to a roofing board and, thereafter, a tile in which an opening is formed is attached. A fixing member for fixing a solar panel is attached to the installation mounting bracket through the opening of the tile. In order to prevent water leakage, the opening of the tile has a shape and a size such that the fitting member can be fitted without any gaps.

In the construction method for a trestle of Japanese Patent No. 6034218, the tile at the installation position of the installation mounting bracket must be removed before attaching the installation mounting bracket. Moreover, after the installation mounting bracket is attached, the tile in which the opening is formed must be attached at the position of the original tile. Furthermore, the installation mounting bracket and the opening of the tile must precisely aligned. As such, the work efficiency of this construction method for a trestle for fixing a solar panel to a roof surface of a house is a problem, and there is a desire for enhancements in the work efficiency.

The present disclosure is made with the view of the above situation, and an objective of the present disclosure is to provide a construction method for a trestle capable of enhancing the work efficiency of installation work of the trestle.

### SUMMARY

A construction method for a trestle according to the present disclosure that achieves the objective described above includes:
forming an opening in a roof tile laid on a roof of a house;
fixing a base of a trestle to a bed of the roof through the opening; and
attaching a first fixing bracket to the base through the opening.

The fixing may include fixing, to the bed of the roof, the base that includes a first groove extending in a first direction, and
the attaching may include attaching the first fixing bracket to a slide member fitted in the first groove so as to be slidable in the first direction.

The construction method for a trestle may include adjusting a position of the first fixing bracket attached to the slide member by sliding the slide member in the first direction.

The attaching of the first fixing bracket may include attaching the first fixing bracket that includes a notch hole at an upper end, and
the construction method for a trestle may include attaching a second fixing bracket to the first fixing bracket by inserting a fastener into the notch hole, and adjusting a height at which the second fixing bracket is attached by a position at which the fastener is inserted into the notch hole.

The attaching of the first fixing bracket may include attaching the first fixing bracket that is formed in a column shape, and the construction method for a trestle may include attaching a fixing unit, for fixing
an installation object to the first fixing bracket, to raise a height of the installation object with respect to the base.

The construction method for a trestle may include repairing by laying and leveling a repairing material on the base that is fixed to the bed of the roof.

In the construction method of a trestle according to the present disclosure, the opening is formed in the tile, and the base is fixed to the bed of the roof through that opening. As such, the construction method of the trestle according to the present disclosure can be carried out while the tile at the installation position of the installation mounting bracket is attached. Furthermore, in the construction method for a trestle according to the present disclosure, alignment of the base and the opening of the tile is easy. As a result, the construction method for the trestle according to the present disclosure can enhance the work efficiency of construction work of the trestle.

### BRIEF DESCRIPTION OF THE DRAWINGS

A more complete understanding of this application can be obtained when the following detailed description is considered in conjunction with the following drawings, in which:

FIG. 1 is a front view of a trestle in a construction method for a trestle according to Embodiment 1 of the present disclosure;

FIG. 2 is a front view illustrating a state in which a base and a first fixing bracket are installed, according to Embodiment 1;

FIG. 3 is a right side view of the base and the first fixing bracket according to Embodiment 1;

FIG. 4 is a perspective view of the base and the first fixing bracket according to Embodiment 1;

FIG. 5 is a plan view of the base according to Embodiment 1;

FIG. 6 is an exploded perspective view illustrating a slide bracket according to Embodiment 1;

FIG. 7 is a cross-sectional view illustrating a cross-section taken along line III-III′ of FIG. 3;

FIG. 8 is a perspective view of the trestle according to Embodiment 1;

FIG. 9 is a perspective view of the fixing bracket according to Embodiment 1;

FIG. 10 is an exploded perspective view of a fixing unit according to Embodiment 1;

FIG. 11 is an exploded front view of the fixing unit according to Embodiment 1;

FIG. 12 is a cross-sectional view illustrating a cross-section taken along line XI-XI′ of FIG. 11;

FIG. 13 is a perspective view illustrating a state in which a solar panel is installed on the fixing unit according to Embodiment 1;

FIG. 14 is a flowchart illustrating the construction method for a trestle according to Embodiment 1;

FIG. 15 is a perspective view of a tile in which an opening is formed, according to Embodiment 1;

FIG. 16 is a perspective view illustrating a state in which the base and the first fixing bracket are installed, according to Embodiment 1;

FIG. 17 is a plan view illustrating the state in which the base and the first fixing bracket are installed, according to Embodiment 1;

FIG. 18 is a right side view illustrating the state in which the base and the first fixing bracket are installed, according to Embodiment 1;

FIG. 19 is a perspective view of a modified example of the trestle according to Embodiment 1;

FIG. 20 is an exploded perspective view of a modified example of the trestle according to Embodiment 1; and

FIG. 21 is a right side view of a modified example of the trestle according to Embodiment 1.

### DETAILED DESCRIPTION

### Embodiment 1

Hereinafter, a trestle 1 according to Embodiment 1 of the present disclosure is described using the drawings. Note that, to facilitate comprehension, XYZ coordinates are set and appropriately referenced.

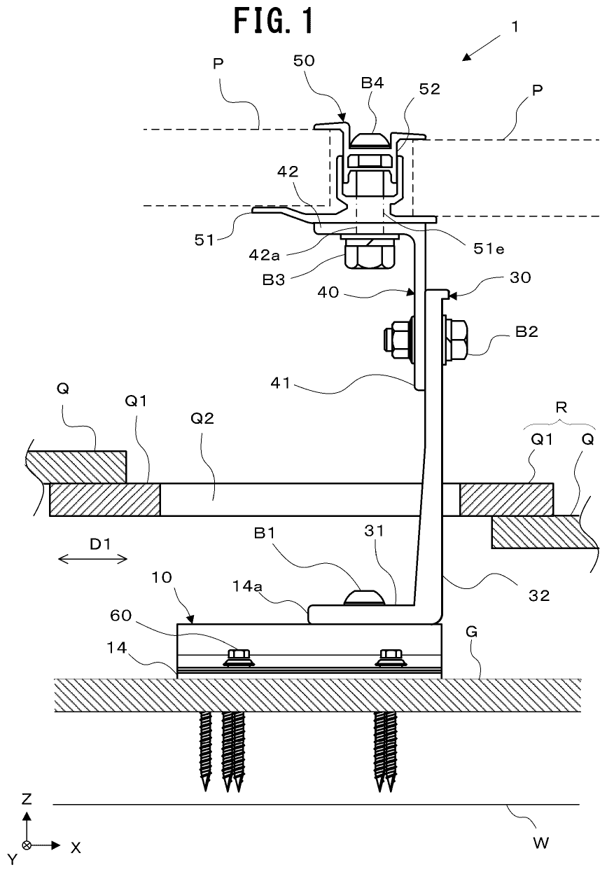

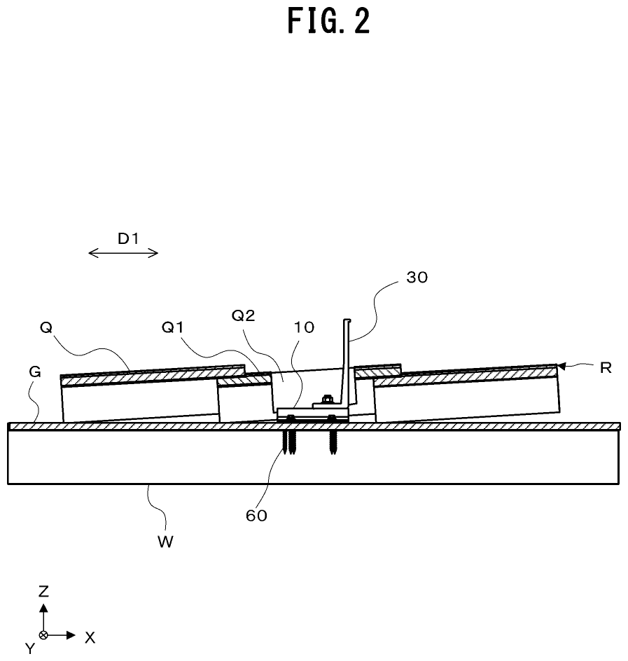

As illustrated in FIGS. 1 and 2, the trestle 1 is, for example, used to support a solar panel P, as an installation object, installed on a surface of a roof surface R formed from tiles Q. The tiles Q are roof tiles that are laid on the roof of a house. The roof surface R formed from the tiles Q is inclined and becomes lower with progression in a +X-axis direction. Note that, in Embodiment 1, the house on which the trestle 1 is mounted is a structure that includes eaves, and ridges disposed upward from the eaves. A direction from a rear toward a head of the tiles Q of the roof surface R on which the trestle 1 of FIGS. 1 and 2 is installed is defined as a +X-axis direction. A direction from a valley center to a ridge of the tiles Q is defined as a +Y-axis direction. A direction orthogonal to the +X-axis direction and the +Y-axis direction is defined as a +Z-axis direction.

As illustrated in FIGS. 1 to 3, the trestle 1 according to Embodiment 1 includes a base 10, a slide bracket 20 (slide member), a first L-shape bracket 30 that is a first fixing bracket, a second L-shape bracket 40 that is a second fixing bracket, a fixing unit 50, a first fastener B1, a second fastener B2, a third fastener B3, and a fourth fastener B4.

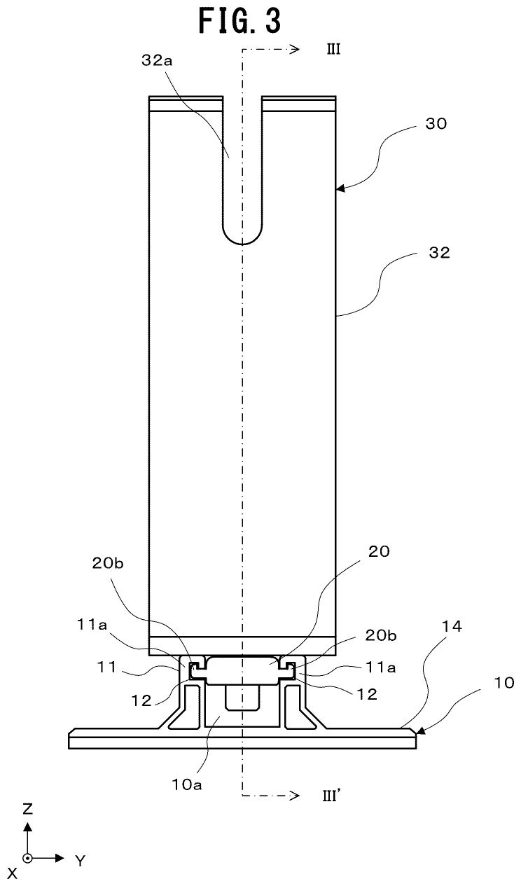

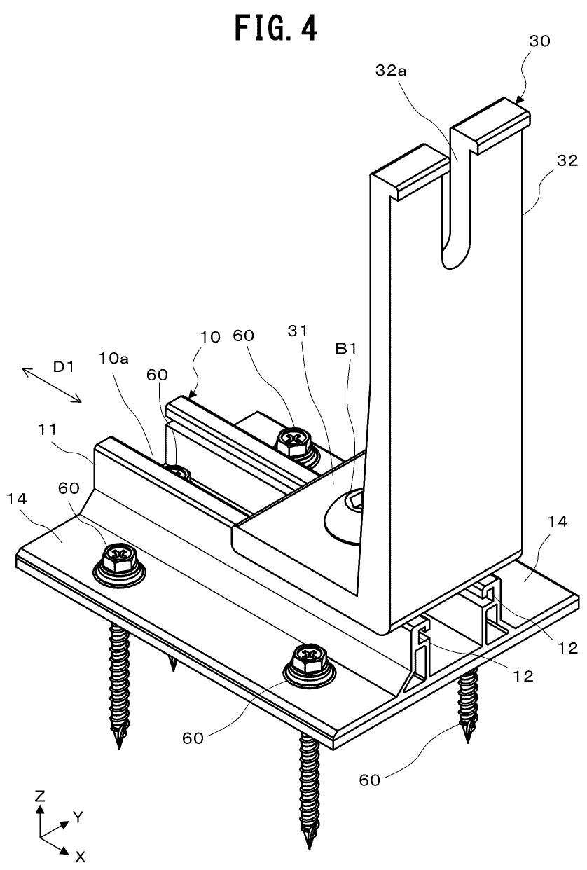

The base 10 is mounted on a roofing board G included in a bed of the roof of the house. As illustrated in FIGS. 3 and 4, a first groove 10a is formed on the base 10. It is sufficient that the base 10 is formed from a material with excellent environmental resistance, durability, and strength such as, for example, stainless steel or another metal. However, the material of the base 10 is not limited thereto. For example, the base 10 may be created from an alloy or a composite material of metals or the like. The base 10 includes a first groove forming portion 11 where the first groove 10a is provided, and plate-like flange portion 14 formed projecting in the +Y-axis direction and the −Y-axis direction from the first groove forming portion 11.

In the first groove forming portion 11, the first groove 10a is formed along a first direction D1 that is the same direction as the X-axis direction. The first groove forming portion 11 includes a pair of side walls 11a, the first groove 10a being formed on an inner side of the pair of side walls 11a. A pair of second grooves 12, in which a portion of the slide bracket 20 fits, is formed on respective opposing surfaces of the pair of side walls 11a.

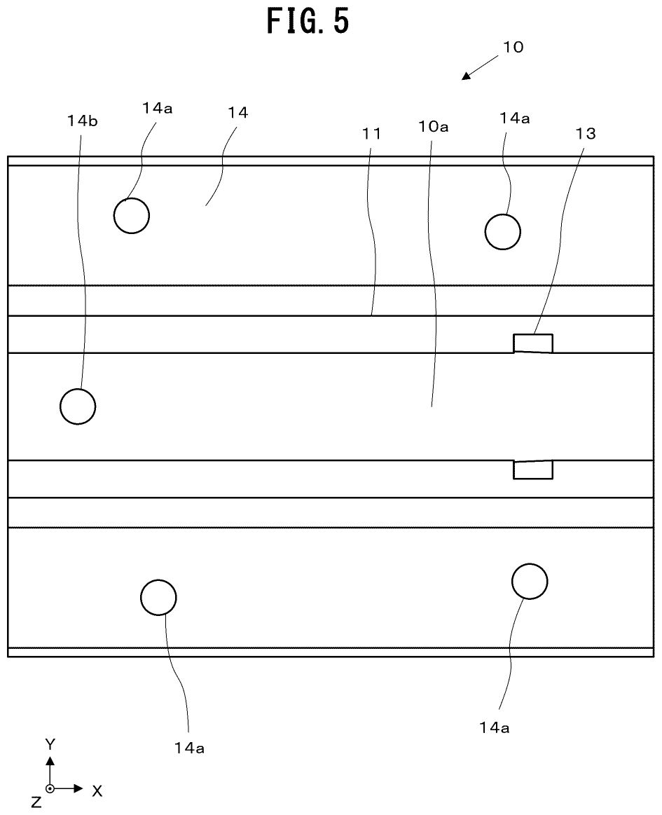

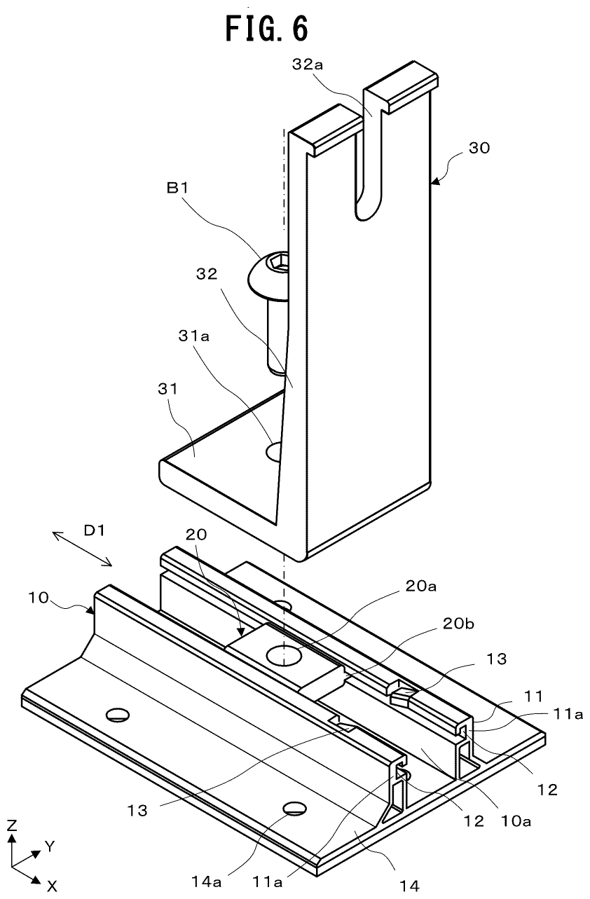

The second grooves 12 are formed so as to extend along the first direction D1 (the X-axis direction), and a YZ cross-section thereof is formed in an L shape. As illustrated in FIGS. 5 and 6, a slide restrictor 13 is formed on the second grooves 12. Note that, in Embodiment 1, the slide restrictor 13 is formed on each of the second grooves 12 and, thus, two are formed. However, the present disclosure is not limited thereto. The slide restrictor 13 may be formed on one of the second grooves 12.

The slide restrictor 13 is formed to restrict sliding, with respect to the base 10, of the slide bracket 20 in the first direction D1. In Embodiment 1, the slide restrictor 13 restricts sliding, with respect to the base 10, of the slide bracket 20 in the +X-axis direction.

Four fastener insertion holes 14a are formed, penetrating in the Z-axis direction, on the flange portion 14. Furthermore, in the base 10, in addition to the four fastener insertion holes 14a, a fastener insertion hole 14b is formed on a bottom surface of the first groove 10a. As illustrated in FIGS. 4 and 5, the fastener insertion holes 14a are round holes into which roof surface mounting fasteners 60 are inserted.

The fastener insertion hole 14b is formed penetrating the base 10 in the Z-axis direction.

As illustrated in FIG. 6, the slide bracket 20 (slide member) is fitted in the first groove 10a of the base 10 so as to be slidable in the first direction D1. In one example, the slide bracket 20 is formed from stainless steel and, specifically, is formed from a metal that is the same material as the base 10. A screw hole 20a, and a pair of fitters 20b are formed on the slide bracket 20.

The first fastener B1 is screwed into the screw hole 20a, and an inner circumferential surface of the screw hole 20a is formed into a female screw surface. The screw hole 20a is formed penetrating the slide bracket 20 in the Z-axis direction.

The fitters 20b are portions that fit in the second grooves 12 formed on the side walls 11a of the base 10. As illustrated in FIG. 3, the fitters 20b are formed such that YZ cross-sections thereof are L-shaped.

As illustrated in FIG. 1, the first L-shape bracket 30 is a bracket that, when viewed from the +Y-axis direction, has an L shape. The first L-shape bracket 30 is formed such that an upper end thereof is positioned upward from the roof surface R. As illustrated in FIG. 6, the first L-shape bracket 30 is installed on the slide bracket 20 by the first fastener B1. In one example, the first L-shape bracket 30 is formed from stainless steel and, specifically, is formed from a metal that is the same material as the base 10 and the slide bracket 20. The first L-shape bracket 30 includes a bottom surface 31 and a first side wall 32.

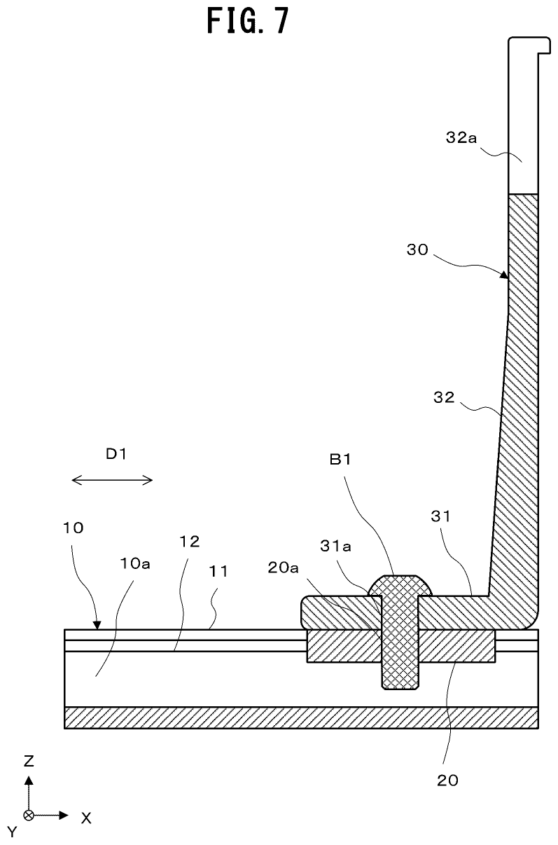

The bottom surface 31 is formed in a plate shape parallel to the XY plane. As illustrated in FIG. 7, a first hole 31a into which the first fastener B1 is inserted is formed on the bottom surface 31.

The first fastener B1 is screwed into the first hole 31a such that a tip of the first fastener B1 is inserted from an upper surface side of the bottom surface 31. The first hole 31a is formed penetrating the bottom surface 31 in the Z-axis direction.

As illustrated in FIGS. 6 to 8, the first side wall 32 is erected on the bottom surface 31, and is formed in a plate shape parallel to the YZ plane. A notch hole 32a into which the second fastener B2 is inserted is formed on an upper end of the first side wall 32. The notch hole 32a of the first side wall 32 is formed penetrating the first side wall 32 in the X-axis direction. The notch hole 32a of the first side wall 32 is formed having a size such that the head of the second fastener B2 does not pass through in the Z-axis direction.

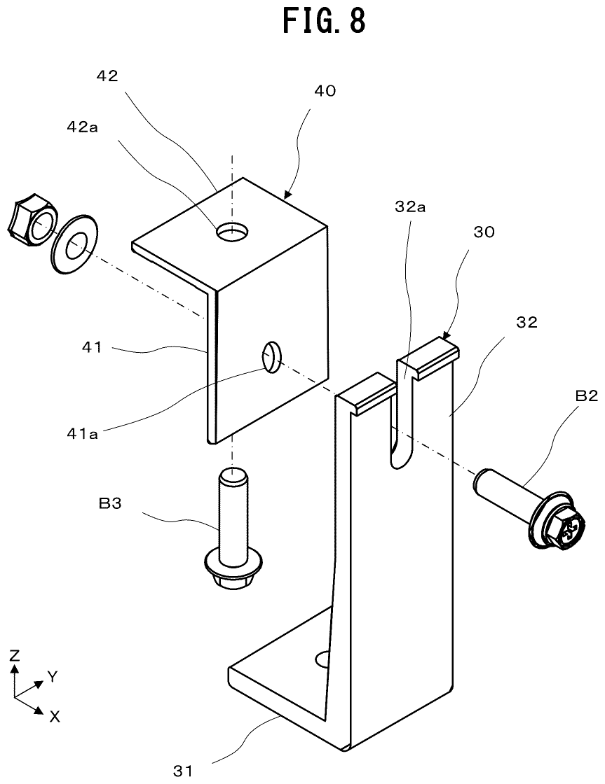

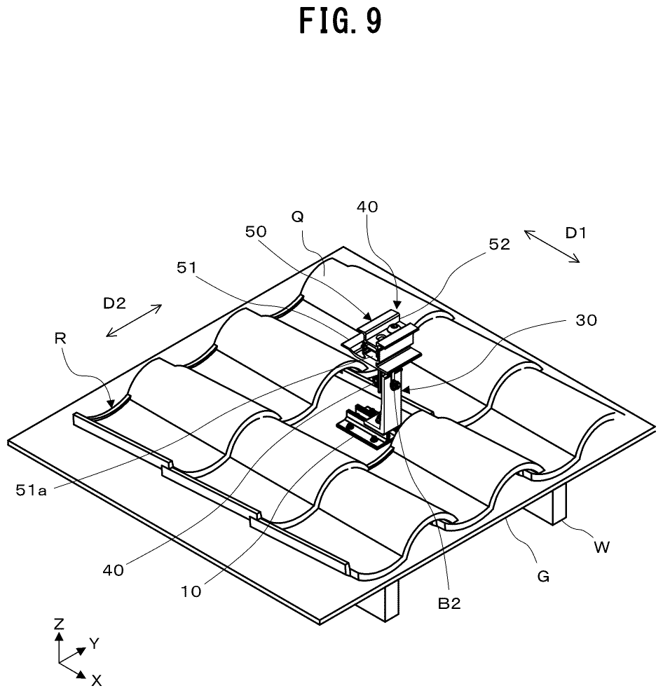

As illustrated in FIG. 1, the second L-shape bracket 40 that is the second fixing bracket is installed on the first L-shape bracket 30 by the second fastener B2. In one example, the second L-shape bracket 40 is formed from stainless steel and, specifically, is formed from a metal that is the same material as the base 10, the slide bracket 20, and the first L-shape bracket 30. In one example, the second L-shape bracket 40 is a conventional bracket, namely an L angle. The second L-shape bracket 40 is disposed so as to have a vertically inverted L-shape when viewed from the −Y-axis direction. However, the present disclosure is not limited thereto. It is sufficient that the second L-shape bracket 40 be formed in a shape having a plate like portion parallel to the YZ plane and a plate like portion parallel to the XZ plane. A second side wall 41 and an upper surface 42 are formed on the second L-shape bracket 40. In FIGS. 8 and 9, the second L-shape bracket 40 that has a short width in the Y-axis direction is supported by one first L-shape bracket 30. However, the present disclosure is not limited thereto. The second L-shape bracket 40 may extend in a second direction D2 that crosses the first direction D1 and be supported by a plurality of first L-shape brackets 30.

The second side wall 41 is formed in a plate shape parallel to the YZ plane. As illustrated in FIG. 8, a second hole 41a into which the second fastener B2 is inserted is formed on the second side wall 41.

The second fastener B2 is screwed into the second hole 41a such that a tip of the second fastener B2 is inserted from a +X-axis direction side surface of the second side wall 41. The second hole 41a is formed penetrating the second side wall 41 in the X-axis direction.

The upper surface 42 is formed in a plate shape parallel to the XZ plane. The upper surface 42 is erected in the −X-axis direction from the upper end (the +Y-side end) of the second side wall 41, and is formed so as to form a right angle with the second side wall 41. A third hole 42a into which the third fastener B3 is inserted is formed on the upper surface 42.

The third fastener B3 is screwed into the third hole 42a such that a tip of the third fastener B3 is inserted from a −Y-axis direction side surface of upper surface 42. The third hole 42a is formed penetrating the upper surface 42 in the Y-axis direction.

As illustrated in FIG. 1, the fixing unit 50 fixes the solar panel P. The fixing unit 50 is installed on the second L-shape bracket 40 by the third fastener B3. In one example, the fixing unit 50 is formed from stainless steel and, specifically, is formed from a metal that is the same material as the base 10, the slide bracket 20, the first L-shape bracket 30, and the second L-shape bracket 40. The fixing unit 50 includes a receiving member 51 and a fixing unit main body 52.

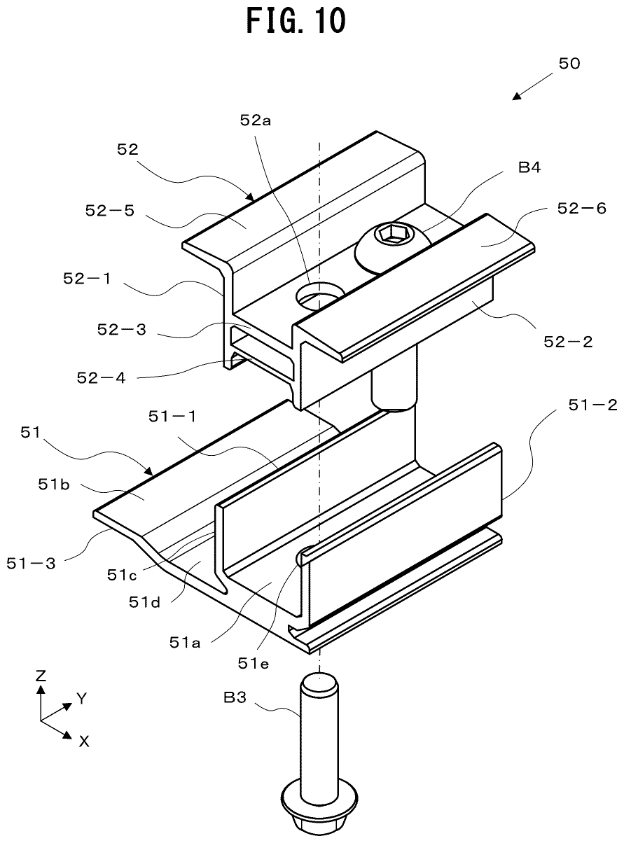

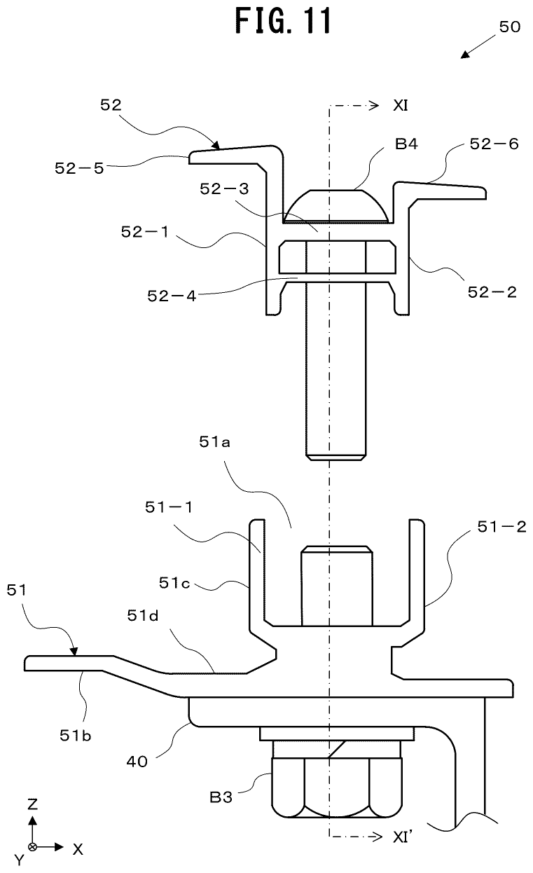

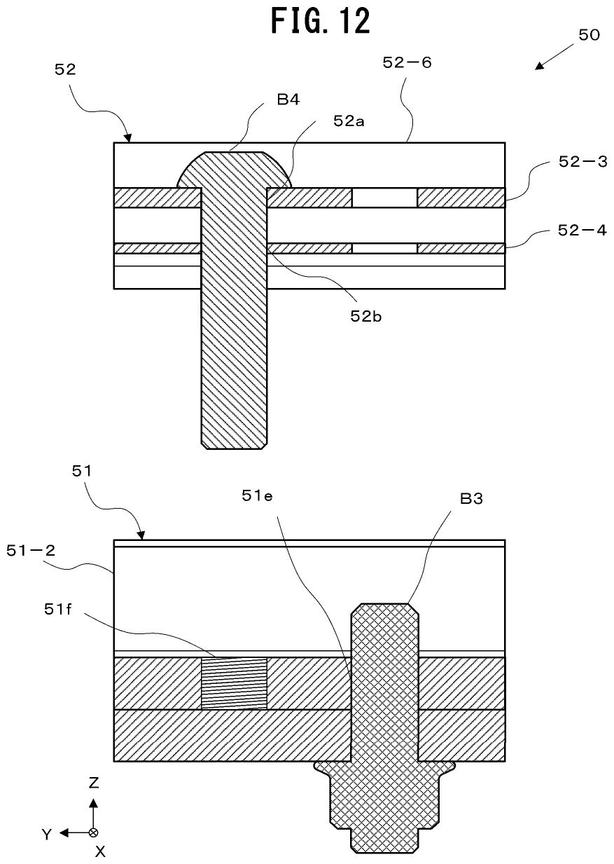

The receiving member 51 is a bracket that receives the fixing unit main body 52. As illustrated in FIG. 9, a groove 51a in which the fixing unit main body 52 is fitted is formed on the receiving member 51 along the second direction D2 that is the same direction as the Y-axis direction. As illustrated in FIGS. 10 to 12, a fourth hole 51e into which the third fastener B3 is inserted, and a screw hole 51f into which the fourth fastener B4 is inserted are formed penetrating a bottom surface of the groove 51a in the Z-axis direction. A mounting surface 51b that serves as a mount, and a pressure receiving surface 51c are formed on the receiving member 51.

The fourth hole 51e is a hole having an inner circumferential surface that is not formed into a female screw surface.

The screw hole 51f is a hole having an inner circumferential surface that is formed into a female screw surface.

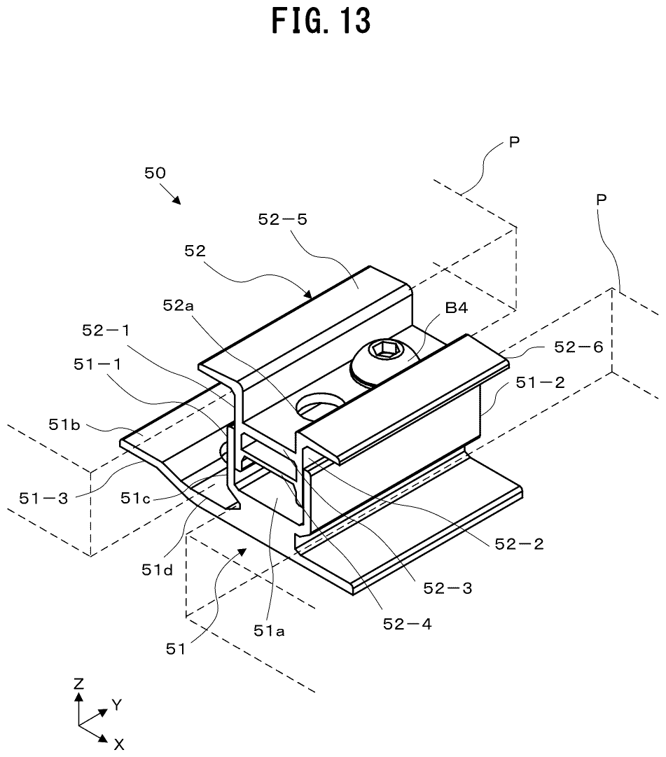

The mounting surface 51b (mount) is provided on an upper surface (the +Z-axis direction side surface) of an extension 51-3 extending from one side wall 51-1 of a pair of side walls 51-1, 51-2, the groove 51a being formed on the inner side of the side walls 51-1, 51-2. As illustrated in FIG. 13, the solar panel P is mounted on the mounting surface 51b. Additionally, the mounting surface 51b is configured from a surface substantially parallel to the XY plane, and a portion of the mounting surface 51b is formed recessed. The portion of the mounting surface 51b that is formed recessed is formed as a depression 51d.

The pressure receiving surface 51c is a surface that receives the weight of the solar panel P that is fixed by the fixing unit 50. The pressure receiving surface 51c is formed on the +X-axis direction side surface of the side wall 51-1, and is formed on a surface parallel to the YZ plane.

As illustrated in FIGS. 10 to 12, the fixing unit main body 52 is a bracket that is fixed to the receiving member 51 by the fourth fastener B4. The fixing unit main body 52 includes side walls 52-1, 52-2, coupling plates 52-3, 52-4, and extensions 52-5, 52-6.

Each of the side walls 52-1, 52-2 is formed in a plate shape parallel to the YZ plane. The side wall 52-1 is provided overlapping the side wall 51-1 of the receiving member 51, with a gap between the side wall 52-1 and the side wall 51-1. The side wall 52-2 is provided overlapping the side wall 51-2 of the receiving member 51, with a gap between the side wall 52-2 and the side wall 51-2.

Each of the coupling plates 52-3, 52-4 is formed in a plate shape parallel to the XY plane. These coupling plates 52-3, 52-4 couple the side walls 52-1, 52-2. A groove extending the Y-axis direction is formed on the inner side of the coupling plate 52-3, disposed upward (on the +Z-axis direction side) from the coupling plate 52-4, and the side walls 52-1, 52-2. A hole into which the third fastener B3 is inserted is formed on the coupling plate 52-3. Likewise, a hole into which the third fastener B3 is inserted is also formed on the coupling plate 52-4.

The extension 52-5 extends from an upper end (+Z-axis direction side end) of the side wall 52-1. A lower surface (−Z-axis direction side surface) of the extension 52-5 functions as a surface that holds down and fixes the solar panel P to the mounting surface 51b. Additionally, the extension 52-5 is formed such that a length in the extending direction (length in the X-axis direction) thereof is shorter than a length in the extending direction (length in the X-axis direction) of the extension 51-3 of the receiving member 51.

The extension 52-6 extends from an upper end (+Z-axis direction side end) of the side wall 52-2 in a direction opposite the extending direction of the extension 52-5. A lower surface (−Z-axis direction side surface) of the extension 52-6 functions as a surface that holds down and fixes the solar panel P.

In the fixing unit main body 52 configured as described above, a fifth hole 52a and a sixth hole 52b that penetrate in the Z-axis direction are respectively formed on the coupling plates 52-3, 52-4. A portion of a +Z-axis direction side head of the first fastener B1 is exposed to the outside through the fifth hole 52a and the sixth hole 52b. Additionally, the fifth hole 52a and the sixth hole 52b are formed having a size such that the head of the third fastener B3 does not pass through in the Z-axis direction.

In one example, the first fastener B1 illustrated in FIG. 7 is constituted from a bolt or a screw. The first fastener B1 is attached to the slide bracket 20 and the first L-shape bracket 30 by being rotated about an axis. The first fastener B1 is attached to the slide bracket and the first L-shape bracket 30 such that the fixing between the slide bracket 20 and the first L-shape bracket 30 illustrated in FIG. 7 can be released while maintaining the fixing between the receiving member 51 and the fixing unit main body 52 by the third fastener B3 illustrated in FIG. 1. Additionally, the first fastener B1 is attached to the slide bracket 20 and the first L-shape bracket 30 such that a lower end of the first fastener B1 protrudes into the first groove 10a of the base 10.

The first fastener B1 is screwed into the screw hole 20a of the slide bracket 20 and fixed. The first fastener B1 does not use a washer and a nut to fix the slide bracket 20 and the first L-shape bracket 30 and, as such, costs can be suppressed. The first fastener B1 is provided such that the axis thereof is parallel to the Z axis.

In one example, the second fastener B2 illustrated in FIG. 8 is constituted from a bolt or screw, a washer, and a nut. The second fastener B2 is attached to the first L-shape bracket 30 and the second L-shape bracket 40 by the bolt or screw being rotated about an axis with respect to the washer and the nut. This second fastener B2 is provided such that the axis thereof is parallel to the X axis.

In one example, the third fastener B3 illustrated in FIGS. 10 to 12 is constituted from a bolt or screw, a washer, and a nut. The third fastener B3 is attached to the second L-shape bracket 40 and the receiving member 51 by the bolt or screw being rotated about an axis with respect to the washer and the nut. The third fastener B3 is provided such that the axis thereof is parallel to the Z axis.

In one example, the fourth fastener B4 is constituted from a bolt or a screw. The fourth fastener B4 is attached to the fixing unit 50 by being rotated around an axis. The fourth fastener B4 is provided such that the axis thereof is parallel to the Z axis.

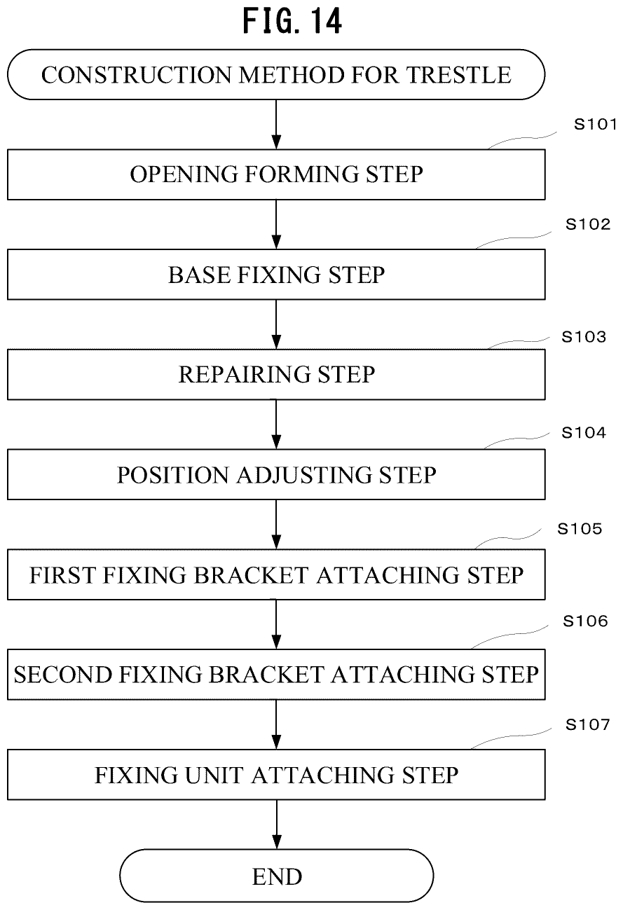

Next, a construction method for the trestle 1 and the steps of that method are described. As illustrated in FIG. 14, the construction method for the trestle 1 includes an opening forming step (step S101), a base fixing step (step S102), a repairing step (step S103), a position adjusting step (step S104), a first fixing bracket attaching step (step S105), a second fixing bracket attaching step (step S106), and a fixing unit attaching step (step S107). In the following, the construction method of the trestle 1 is described using the flowchart.

A user determines, in advance, the position of the solar panel P to be installed on the roof surface R illustrated in FIG. 1. Since the roof surface R is inclined, the user determines the position of the solar panel P such that the solar panel P conforms to the incline of the roof surface R. In one example, the user determines the position of the solar panel P such that a lower end of the solar panel P is parallel to the Y axis. Furthermore, in one example, the user can determine the position of the solar panel P so as to arrange a plurality of solar panels P along the incline of the roof surface R.

Then, the user determines a position at which to provide the trestle 1 that supports the solar panel P. In one example, the user determines to provide a plurality of trestles 1 at the lower end of the solar panel P. Furthermore, in one example, the user can determine the position at which to provide the trestles 1 such that the trestles 1 provided at the lower end of the solar panel P hold down and fix an upper end of another solar panel P provided downward from the solar panel P. In the following, the tile Q located at the position at which the trestle 1 is provided is defined as a tile Q1. As with the other tiles Q, the tile Q1 is a roof tile that is laid on the roof of the house.

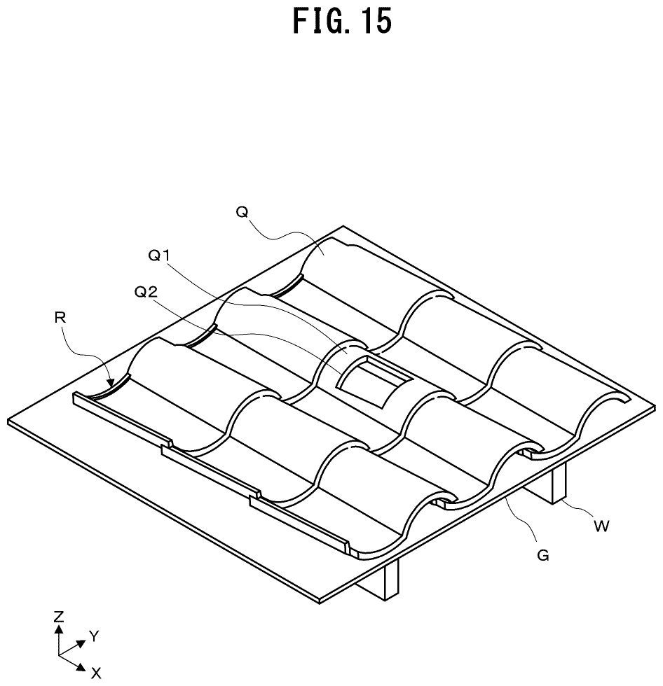

Next, in the opening forming step (step S101; FIG. 14), the user cuts the tile Q1 to form an opening Q2 as illustrated in FIG. 15. In one example, the user forms the opening Q2 using a disc grinder. The user cuts the tile Q1 by pressing the blade of the disc grinder downward (in the −Z-axis direction) from an upper surface (+Z-axis direction side surface) of the tile Q1. However, the present disclosure is not limited thereto. It is sufficient that the user can cut the tile Q1 to form the opening Q2. For example, the user may form the opening Q2 using a portable grinder.

The user forms the opening Q2 so as to penetrate the tile Q1 in the Z-axis direction. As illustrated in FIG. 1, the user forms the opening Q2 having a size capable of passing the base 10. As illustrated in FIG. 15, the user forms the opening Q2 in a rectangle in which the two pairs of sides are parallel to the Y axis and the X axis. However, the present disclosure is not limited thereto. For example, the user may form the opening Q2 in a trapezoidal shape or a rectangular shape in which the four sides are distorted so as to match the shape of the tile Q1.

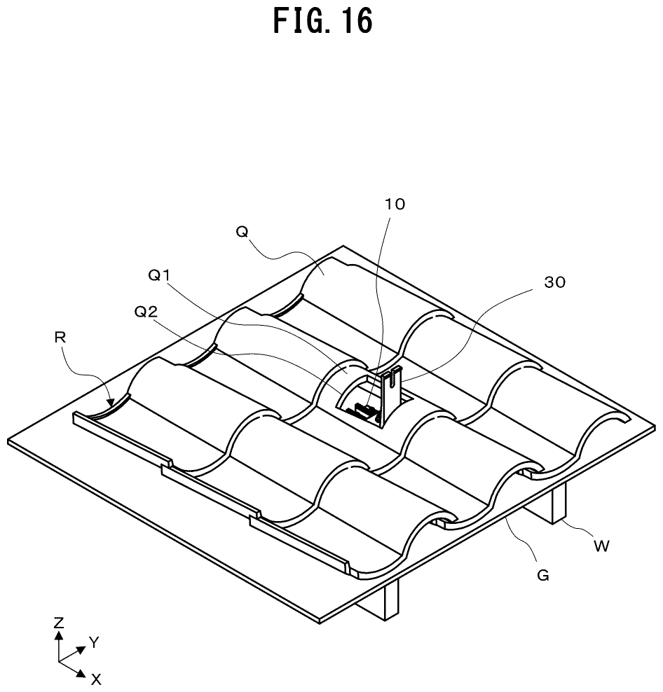

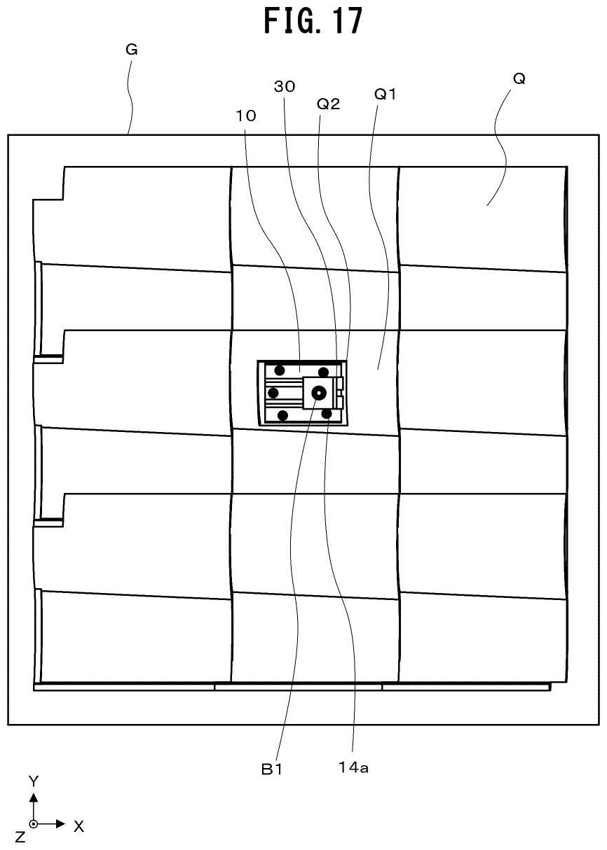

Next, in the base fixing step (step S102; FIG. 14), the user positions, through the opening Q2 illustrated in FIG. 15, the base 10 on the roofing board G under the tile Q1. As illustrated in FIGS. 2 to 4, the user disposes the base 10 such that the first groove 10a is aligned along the first direction D1. Then, as illustrated in FIGS. 4 and 5, the user inserts the roof surface mounting fasteners 60 into the fastener insertion holes 14a of the base 10. Furthermore, as illustrated in FIG. 1, the user fixes the roof surface mounting fasteners 60 to the roofing board G. As a result, the user fixes the base 10 to the roofing board G, that is the bed of the roof, through the opening Q2 as illustrated in FIGS. 16 to 18.

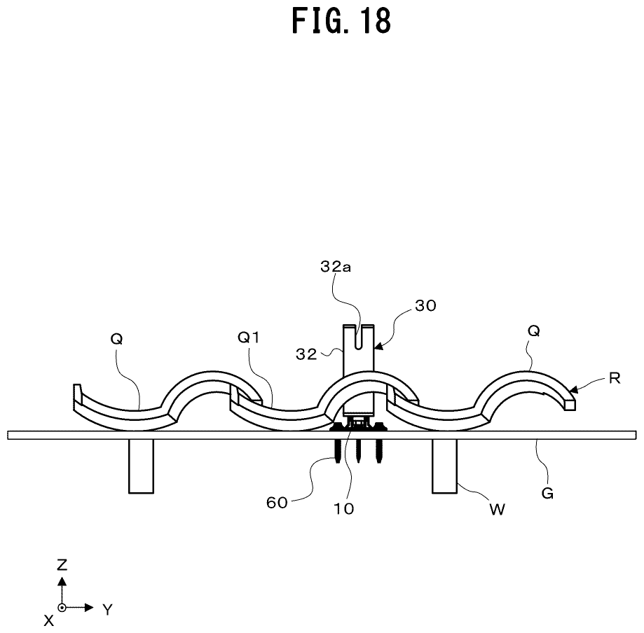

In the repairing step (step S103; FIG. 14), the user repairs by laying and leveling a repairing material (not illustrated) on the base 10 fixed to the bed of the roof in order to close gaps that opened in the roofing board G, that is included in the bed of the roof, due to the roof surface mounting fasteners 60 illustrated in FIG. 18.

In the position adjusting step (step S104; FIG. 14), the user aligns the slide bracket and the first L-shape bracket 30 through the opening Q2 illustrated in FIGS. 6 and 7. The slide bracket 20 is fitted into the first groove 10a of the base 10. The tip of the first fastener B1 protrudes from the upper surface of the slide bracket 20. Then, in the first fixing bracket attaching step (step S105; FIG. 14), the user inserts the first fastener B1 into the first hole 31a of the bottom surface 31 of the first L-shape bracket 30 illustrated in FIGS. 6 and 7, and attaches the first L-shape bracket 30 to the slide bracket 20. As a result, the user attaches the first L-shape bracket 30 to the slide bracket 20 and the base 10. The user can loosen the first fastener B1 and, as illustrated in FIGS. 6 and 7, slide the slide bracket 20 in the first direction D1 to adjust the position of the first L-shape bracket 30 attached to the slide bracket 20.

As illustrated in FIG. 1, the upper end of the first L-shape bracket 30 attached to the slide bracket 20 protrudes through the opening Q2 to above the tile Q1.

In the second fixing bracket attaching step (step S106; FIG. 14), as illustrated in FIG. 8, the user disposes the second L-shape bracket 40 such that the second side wall 41 contacts the first side wall 32 of the first L-shape bracket 30. Furthermore, the user aligns the second L-shape bracket 40 such that the second hole 41a of the second side wall 41 and the notch hole 32a of the first side wall 32 are continuous. Then, the user inserts the second fastener B2 into the notch hole 32a and the second hole 41a, and fixes the first L-shape bracket 30 and the second L-shape bracket 40. As a result, the user attaches the second L-shape bracket 40 to the first L-shape bracket 30. The user can adjust the height at which the second L-shape bracket 40 is attached by the position at which the second fastener B2 is inserted into the notch hole 32a.

The user aligns the second L-shape bracket 40 and the receiving member 51. As illustrated in FIG. 9, the user disposes the receiving member 51 such that groove 51a is aligned along the second direction D2. Then, in the fixing unit attaching step (step S107; FIG. 14), as illustrated in FIG. 1, the user inserts the third fastener B3 into the third hole 42a and the fourth hole 51e, and fixes the second L-shape bracket 40 and the receiving member 51 of the fixing unit 50. As a result, the user attaches the fixing unit 50 that fixes the solar panel P, that is the installation object, to the second L-shape bracket 40.

Finally, as illustrated in FIG. 13, the user mounts the solar panel P on the mounting surface 51b of the receiving member 51. When the solar panel P is mounted on the mounting surface 51b, as illustrated in FIG. 13, the pressure receiving surface 51c of the receiving member 51 receives the weight of the solar panel P. Then, the user disposes the fixing unit main body 52 such that the extension 52-5 of the fixing unit main body 52 holds down and fixes the upper surface of the solar panel P. Furthermore, as illustrated in FIGS. 10 to 12, the user inserts the fourth fastener B4 into the screw hole 51f of the receiving member 51 and the fifth hole 52a of the fixing unit main body 52. The receiving member 51 and the fixing unit main body 52 are fixed to each other by the fourth fastener B4.

As described above, in the construction method of the trestle 1 according to Embodiment 1, the opening Q2 is formed in the tile Q1, and the base 10 and the first L-shape bracket 30 are attached through the opening Q2. As a result, the base 10 and the first L-shape bracket 30, and the opening Q2 of the tile Q1 can be easily aligned. As such, the work efficiency of installation work of the trestle can be enhanced.

Additionally, in the construction method of the trestle 1 according to Embodiment 1, the repairing material is laid and leveled on the base 10 to repair the gaps that form due to the roof surface mounting fasteners 60 being fixed to the roofing board G. As a result, even if rainwater leaks to the roofing board G below the tile Q through the gaps formed between the first L-shape bracket 30 and the opening Q2 of the tile Q1, the rainwater does not intrude below the roofing board G. Moreover, even if the amount of rainwater that leaks to the roofing board G increases, the possibility of the rainwater intruding can be suppressed due to the repairing material and, as such, the opening Q2 of the tile Q1 can be made larger. Due to this, it is easier to pass the first L-shape bracket 30 through the opening Q2 of the tile Q1, and the work efficiency of installation work of the trestle can be enhanced.

In the construction method of the trestle 1 according to Embodiment 1, the user can position the solar panel P in the first direction D1 illustrated in FIG. 1 by attaching the slide bracket 20 to the base 10 illustrated in FIG. 6 at a desired position in the first direction D1. As such, the construction method of the trestle 1 according to Embodiment 1 can enhance the work efficiency of installation work of the trestle.

An embodiment of the present disclosure is described above, but the present disclosure is not limited by the embodiment described above.

In Embodiment 1, the roof surface mounting fasteners 60 are fixed to the roofing board G. However, the present disclosure is not limited thereto. A configuration is possible in which the roof surface mounting fasteners 60 are fixed to the roofing board G and a rafter W that is included in the bed of the roof.

In Embodiment 1, the fixing unit 50 is fixed to the second L-shape bracket 40 that is attached to the first L-shape bracket 30. However, the present disclosure is not limited thereto. A configuration is possible in which the fixing unit 50 has a structure that is directly fixed to the first L-shape bracket 30.

In Embodiment 1, the second L-shape bracket 40, the receiving member 51, and the fixing unit main body 52 are fixed by the third fastener B3 and the fourth fastener B4. However, the present disclosure is not limited thereto. A configuration is possible in which the second L-shape bracket 40, the receiving member 51, and the fixing unit main body 52 are fixed by one fastener.

In Embodiment 1, the receiving member 51 and the second L-shape bracket 40 are fixed by the third fastener B3. However, the present disclosure is not limited thereto. A configuration is possible in which a spacer is provided between the receiving member 51 and the second L-shape bracket 40. The receiving member 51 and the second L-shape bracket 40 are fixed by the third fastener B3 while sandwiching the spacer. In the construction method of the trestle 1, work efficiency of installation work of the trestle can be enhanced by adjusting the height of the receiving member 51. In one example, the spacer is formed in a U-shape. However, the present disclosure is not limited thereto. It is sufficient that the spacer can adjust the distance between the receiving member 51 and the second L-shape bracket 40. The spacer may, for example, be ring-shaped.

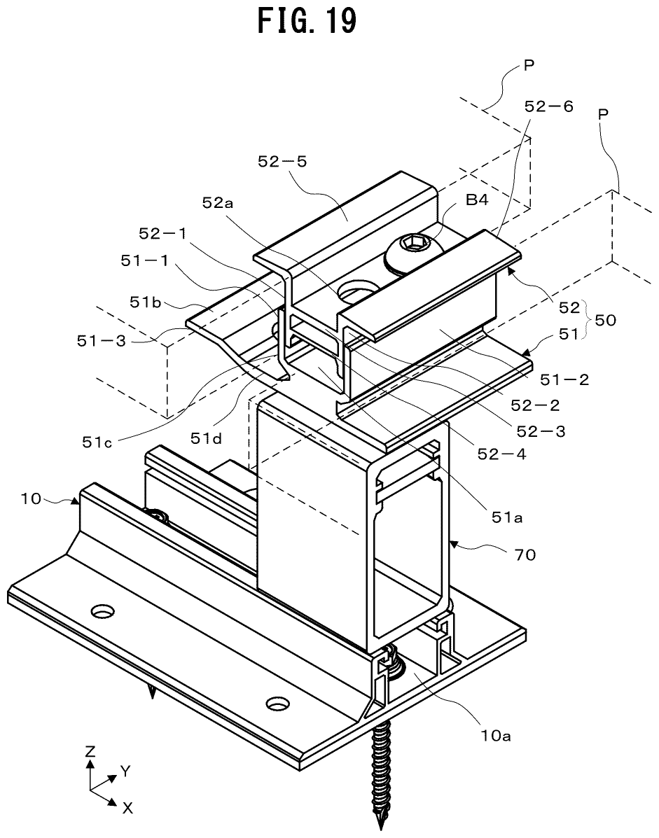

In Embodiment 1, as illustrated in FIG. 1, the first fixing bracket is the first L-shape bracket 30 that has an L-shape when viewed from the +Y-axis direction. Moreover, the fixing unit 50 is mounted on the second L-shape bracket 40 that is attached to the first L-shape bracket 30. However, the present disclosure is not limited thereto. For example, a configuration is possible in which, as illustrated in FIG. 19, the first fixing bracket is a relay member 70 formed in a column shape, and the fixing unit 50 is mounted on the relay member 70.

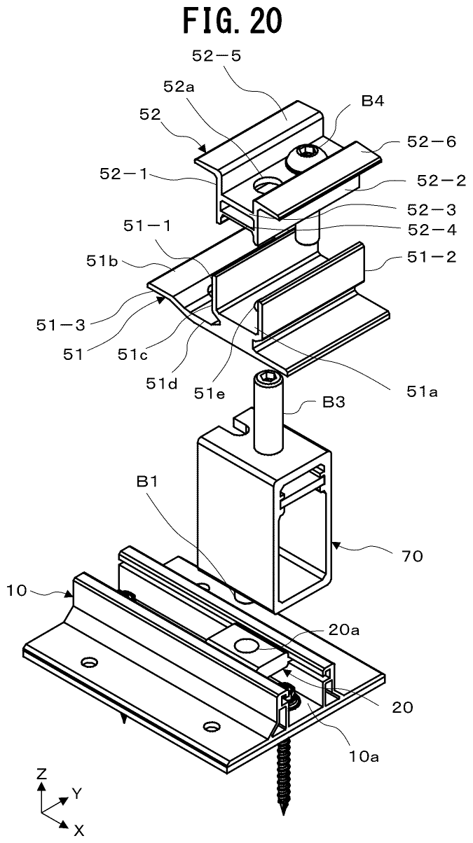

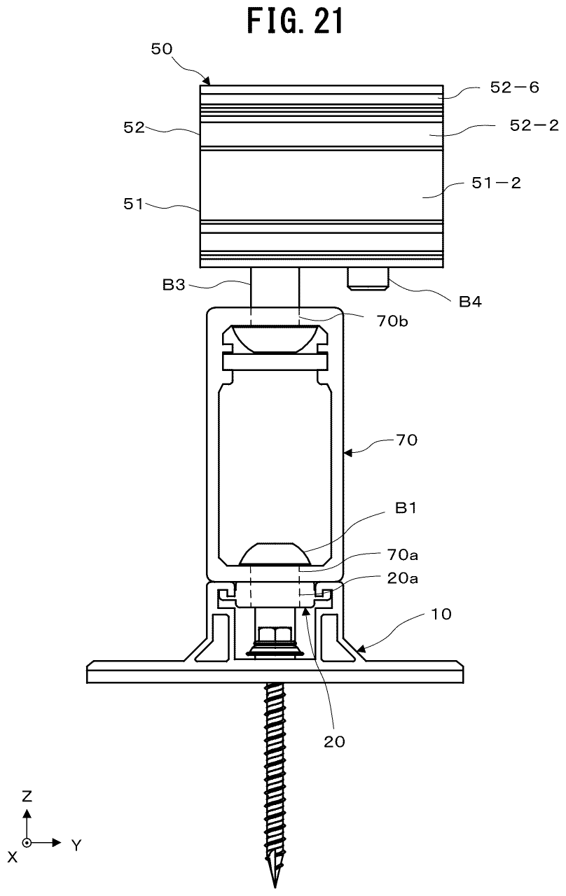

As illustrated in FIGS. 19 and 20, the relay member 70 is a bracket that is fixed to the slide bracket 20 and supports the receiving member 51, and that is used to raise the position of the fixing unit 50 with respect to the base 10. As illustrated in FIG. 21, a seventh hole 70a into which the first fastener B1 is screwed is formed on the relay member 70. Furthermore, an eighth hole 70b into which the third fastener B3 is screwed is formed on the relay member 70.

Moreover, in the fixing unit attaching step (step S107; FIG. 14), as illustrated in FIGS. 20 and 21, the user inserts the third fastener B3 that is screwed into the eighth hole 70b into the fourth hole 51e, and fixes the relay member 70 and the receiving member 51 of the fixing unit 50. As illustrated in FIG. 19, the user can raise the height of the solar panel P with respect to the base 10 by attaching the fixing unit 50, that fixes the solar panel P, to the relay member 70.

In Embodiment 1, as illustrated in FIG. 1, the solar panel P is fixed to the fixing unit 50. However, the present disclosure is not limited thereto. For example, a configuration is possible in which the solar panel P is mounted on a rail attached to the first L-shape bracket 30, and is supported by an end clamp, that fixes the solar panel P, provided at an end of the rail.

In Embodiment 1, the installation object of the trestle 1 is the solar panel P. However, the present disclosure is not limited thereto. The installation object of the trestle 1 may be an object other than the solar panel P. For example, the installation object of the trestle 1 may be an antenna such as a parabolic antenna, or a solar water heater.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.
1 Trestle
10 Base
10a First groove
11 First groove forming portion
11a Side wall
12 Second groove
13 Slide restrictor
14 Flange portion
14a, 14b Fastener insertion hole
20 Slide bracket (slide member)
20a Screw hole
20b Fitter
30 First L-shape bracket
31 Bottom surface
31a First hole
32 First side wall
32a Notch hole
40 Second L-shape bracket
41 Second side wall
41a Second hole
42 Upper surface
42a Third hole
50 Fixing unit
51 Receiving member
51-1, 51-2 Side wall
51-3 Extension
51a Groove
51b Mounting surface (mount)
51c Pressure receiving surface
51d Depression
51e Fourth hole
51f Screw hole
52 Fixing unit main body
52-1, 52-2 Side wall
52-3, 52-4 Coupling plate
52-5, 52-6 Extension
52a Fifth hole
52b Sixth hole
60 Roof surface mounting fastener
70 Relay member
70a Seventh hole
70b Eighth hole
B1 First fastener
B2 Second fastener
B3 Third fastener
B4 Fourth fastener
G Roofing board
W Rafter
P Solar panel
Q, Q1 Tile
Q2 Opening
R Roof surface
D1 First direction
D2 Second direction

What is claimed is:

1. A construction method for a trestle, the construction method comprising:
forming an opening in a roof tile laid on a roof of a house;
fixing a base of a trestle to a bed of the roof through the opening; and
attaching a first fixing bracket to the base through the opening.

2. The construction method for a trestle according to claim 1, wherein
the fixing includes fixing, to the bed of the roof, the base that includes a first groove extending in a first direction, and
the attaching includes attaching the first fixing bracket to a slide member fitted in the first groove so as to be slidable in the first direction.

3. The construction method for a trestle according to claim 2, further comprising:
adjusting a position of the first fixing bracket attached to the slide member by sliding the slide member in the first direction.

4. The construction method for a trestle according to claim 1, wherein
the attaching of the first fixing bracket includes attaching the first fixing bracket that includes a notch hole at an upper end, and
the construction method for a trestle further comprises attaching a second fixing bracket to the first fixing bracket by inserting a fastener in the notch hole, and adjusting a height at which the second fixing bracket is attached by a position at which the fastener is inserted into the notch hole.

5. The construction method for a trestle according to claim 1, wherein
the attaching of the first fixing bracket includes attaching the first fixing bracket that is formed in a column shape, and
the construction method for a trestle further comprises attaching a fixing unit, for fixing an installation object to the first fixing bracket, to raise a height of the installation object with respect to the base.

6. The construction method for a trestle according to claim 1, further comprising:
repairing by laying and leveling a repairing material on the base that is fixed to the bed of the roof.
